(19) United States
(12) Patent Application Publication
(10) Pub. No.: US 2018/0253143 A1
(43) Pub. Date: Sep. 6, 2018

(54) SELF-ALIGNED SCREEN

(71) Applicant: Ahmad ISMAIL YOUSEF SALEEM, Mississauga (CA)

(72) Inventor: Ahmad ISMAIL YOUSEF SALEEM, Mississauga (CA)

(21) Appl. No.: 15/240,243

(22) Filed: Aug. 18, 2016

(51) Int. Cl. G06F 3/01; G06K 9/00; G09G 5/00

(52) U.S. Cl. CPC G06F 3/013; G06K 9/00248; G09G 2354/00; G06K 9/00013; G06K 9/00604; G09G 5/003

(57) ABSTRACT

The present invention is an alignment system for a screen for an optimum view by a user, the system comprising of a positioning mechanism attached to the screen to adjust the viewing position of the screen by translation and rotation; a camera located on the screen to capture an image of the user's face; an image processing algorithm to determine the position of the user's eyes with respect to the screen; a preferred location determination algorithm to define a preferred position for said user's eyes with respect to the screen; a set of alignment parameters to adjust the screen vertically and horizontally for the optimum view of the screen by the user, whereby, said camera captures user's image and adjusts the screen location and angle to match the alignment parameters.

### FIELD OF THE INVENTION

The present invention relates in general to electronic devices and in particular to an alignment system to align computer monitors and laptop screens with the line sight of a user.

### BACKGROUND OF THE INVENTION

Computers have become part of almost everyone's daily life. Prolonged computer use can increase chances of developing an injury; in particular, an inappropriate computer use can cause muscle and joint pain. Studies have shown that prolonged use of computers is a major contributing factor of sedentary lifestyle. Muscle fatigue and shoulder pain are the most common complaints of regular computer users with inappropriate posture.

In order to prevent injuries, it is recommended that a computer monitor or a laptop screen be located slightly below the eye-level. The top part of the screen should be at the eye-level or slightly below the eye-level. The distance between the user's face and the screen should be about arm's length. Also the user should not lean forward to see the monitor, which may put extra strain on the user's neck.

The alignment of the screen depends on the angle of the user face with the screen, the distance from the screen and the height of the user. Usually, a user may align the computer monitor one time during the day and look at the same aligned monitor while he/she takes different postures or even moves in his/her chair. However, the location of the monitor is usually fixed to the first adjustment by the user.

The present invention provides a self-aligned computer monitor or a screen which is adjusted by the position of the user. The new system aligns the screen automatically while the user is behind it.

### SUMMARY OF THE INVENTION

The present invention is a system for a computer monitor or screen alignment. It utilizes a vision software together with a mechanical system to align a monitor for a user.

The present invention is an alignment system for a screen for an optimum view by a user, said system comprising of a positioning mechanism attached to the screen to adjust the viewing position of the screen by translation and rotation; a camera located on the screen to capture an image of the user's face; an image processing algorithm to determine the position of the user's eyes with respect to the screen; a preferred location determination algorithm to define a preferred position for said user's eyes with respect to the screen; a set of alignment parameters to adjust the screen vertically and horizontally for the optimum view of the screen by the user, whereby, said camera captures user's image and adjusts the screen location and angle to match the alignment parameters.

The present invention comprises of a first gear system to control tilting movement of a screen, a second gear system to control rotating movement of the screen, and a software to detect the location of a user's face and user's eyes and to control the gear systems to align the screen. The default criterion for proper alignment is to locate user's face (as imaged by the screen camera) in the middle of the screen. The user may define other criteria for the alignment.

The present invention further comprises of a software for opening and closing the screen of a laptop. The software opens the screen to a predefined initial angle (e.g. 85 degrees). In order to align the screen towards the user, the software turns on the screen camera and starts image processing together. The software moves the screen until user's face is located in the middle of the screen. The alignment is achieved when user's face (as imaged by the camera) is located in the middle of the screen.

The present invention is a method to align a screen for optimum viewing by a user, wherein said screen having an upper side, a left side, a screen-width and a screen-height, said method comprising of steps of capturing an image of said user and importing on said screen; defining an X-axis as said upper side of said screen; defining an Y-axis as said left side of said screen; determining a current location of said user's face or said user's eyes based on said X-axis and Y-axis; defining a preferred location for said user's face or user's eyes on said screen based on said X-axis and Y-axis; adjusting said screen from said current location to said preferred location in said Y-axis direction; and adjusting said screen from said current location to said preferred location in said X-axis direction.

The first objective of the present invention is to provide a system for screen alignment based on the position of the user's face and the user's eyes.

The second objective of the present invention is to provide a system to manually or automatically align a screen based on the preferences of a user or align to a predefined location.

The third objective of the present invention is to provide a system to decrease the health issue related to inappropriate positions of a user in front of a screen.

The forth objective of the present invention is to provide a system to decrease the hardware issues related to the hinge systems in laptops.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a laptop computer with the present invention assembly;

FIG. 2A shows a laptop computer when its screen is closed;

FIG. 2B shows a laptop computer when its screen is being opened by the present system;

FIG. 2C shows a laptop computer when its screen is being opened by the present system;

FIG. 3A shows a laptop computer when its screen is being closed by the present invention;

FIG. 3B shows a laptop computer when the screen is being closed by the present system;

FIG. 3C shows a laptop computer when the screen is closed;

FIG. 4A shows a laptop computer when the screen is in normal position;

FIG. 4B shows a laptop computer when the screen is rotated to the left by the present system;

FIG. 4C shows a laptop computer when the screen is rotated to the right by the present system;

FIG. 5 shows the components for the alignment assembly in the present device;

FIG. 6A shows a screen and an image processing system;

FIG. 6B shows a laptop computer and the angle which is changed by the alignment assembly of the present invention;

FIG. 7A shows a laptop computer placed on top of a platform of the present invention;

FIG. 7B shows the platform of a present invention;

FIG. 7C shows the platform of a present invention;

FIG. 7D shows the platform of a present invention;

FIG. 7E shows the platform of a present invention;

FIG. 8 shows a schematic diagram of the opening mechanism for the present invention;

FIG. 9 shows a schematic diagram of the calibration mode of the present invention;

FIG. 10 shows a schematic diagram of the automatic alignment mode of the present invention;

FIG. 11 shows a schematic diagram of the manual alignment mode by a user for the present invention;

FIG. 12 shows a schematic diagram for different embodiment for the screen alignment of the present invention, and

FIG. 13 shows a schematic diagram of the whole structure of the present invention.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

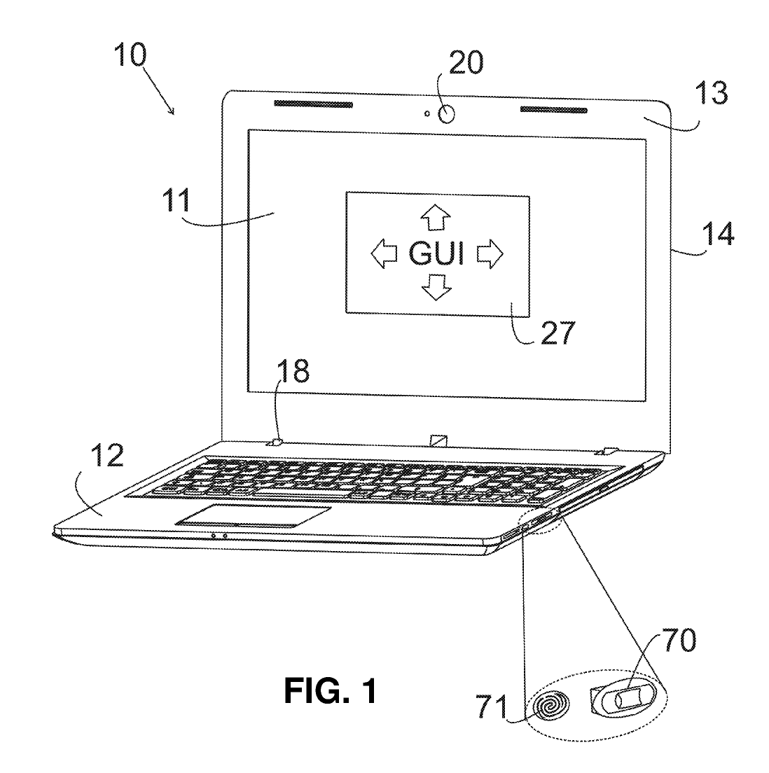

FIG. 1 shows a laptop computer 10 structured to have a screen 11 hingedly coupled to a keyboard 12. The laptop computer 10 has a camera 20 located at the front portion 13 of the screen 11. The screen 11 connects to the keyboard 12 by an assembly 18. The assembly of the present invention is responsible to hingedly open and close the screen 11.

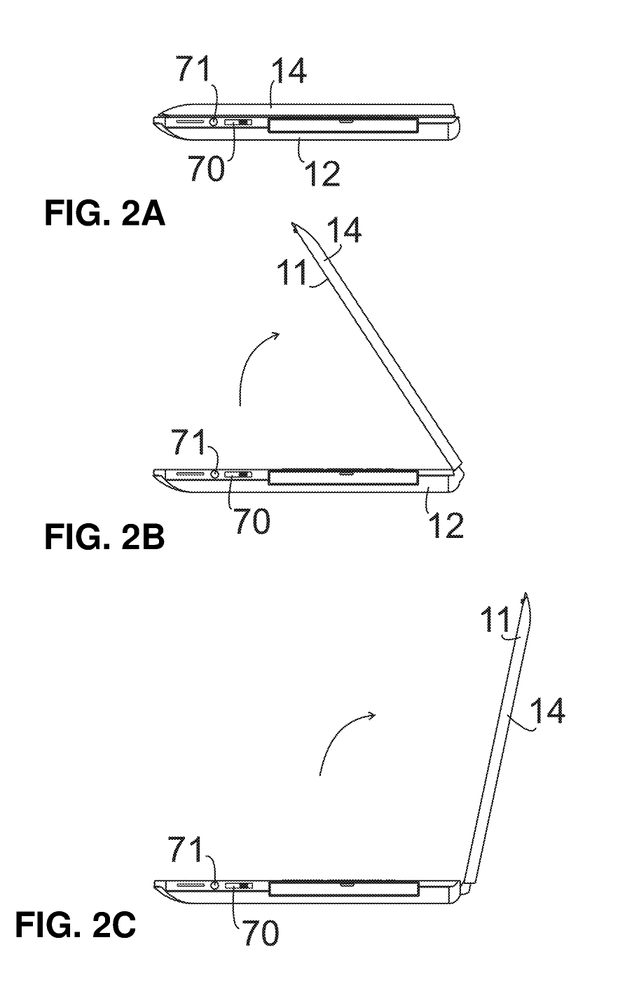

FIGS. 2A, 2B and 2C, show the laptop computer 10 in three positions. The laptop screen 11 is closed in the FIG. 2A. Once the user moves a sliding switch 70 forward and hold it for two seconds, this new assembly and system will open the screen 11 to a predefined initial angle (e.g. 85 degrees).

The present invention can automatically align the screen 11. The system opens the camera and starts image processing and controls the alignment by motors and accelerometer's position feedback to locate user's face in the middle of the screen 11.

The software for the screen positioning can be programmed by a user to open the screen to user's preferred angle. The sliding switch 70 activates the motors in the lateral gears system and tilts the screen to the user preferred position.

In the present invention the position feedback uses the accelerometer to return back to the last saved position. The user can save several different positions for the screen and refer to any of the saved positions as desired.

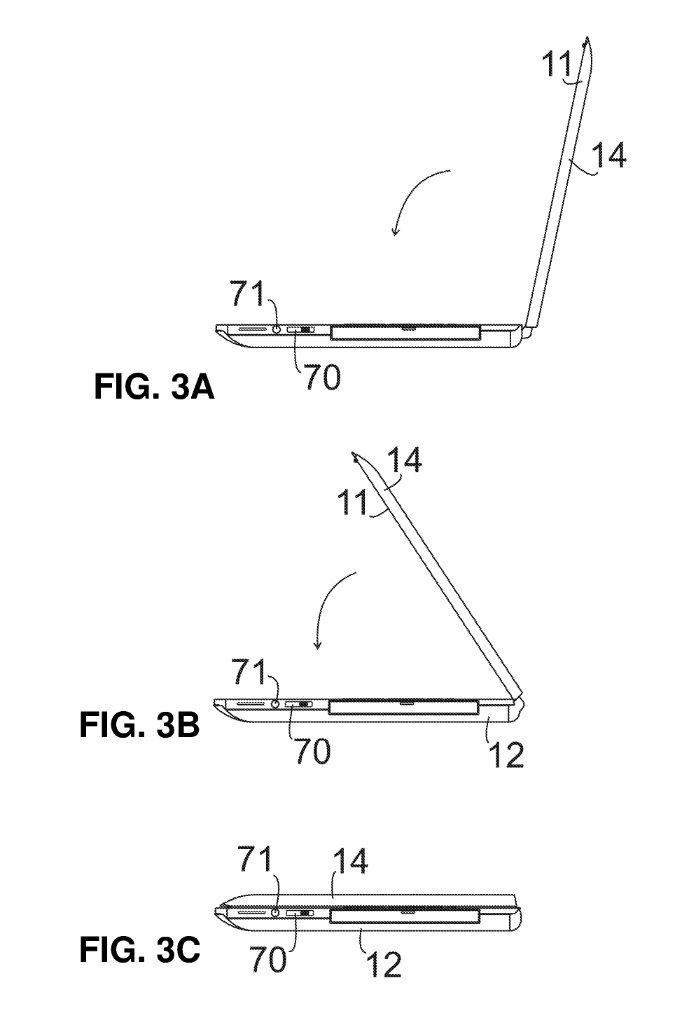

FIGS. 3A, 3B and 3C show the laptop computer 10 in three positions. The laptop screen 11 is in open position in the FIG. 3A. Once the user moves a sliding switch 70 backward and holds it for two seconds, the present system will close the screen 11.

If the user powers off\sleeps\hibernates the laptop, the screen 11 closes automatically after a predefined period of time (e.g. 15 seconds). The screen closing mechanism can be done manually if the user slides the sliding switch down and keep it for a predefined period of time (e.g. 2 seconds).

Again as shown in FIG. 1, a fingerprint scanner 71 may be used for security purposes, so that the user authenticates his\her fingerprint before he\she can use the sliding switch 70 to open the screen 11. Therefore, the laptop screen 11 can only be opened by an authorized user, and remains closed otherwise.

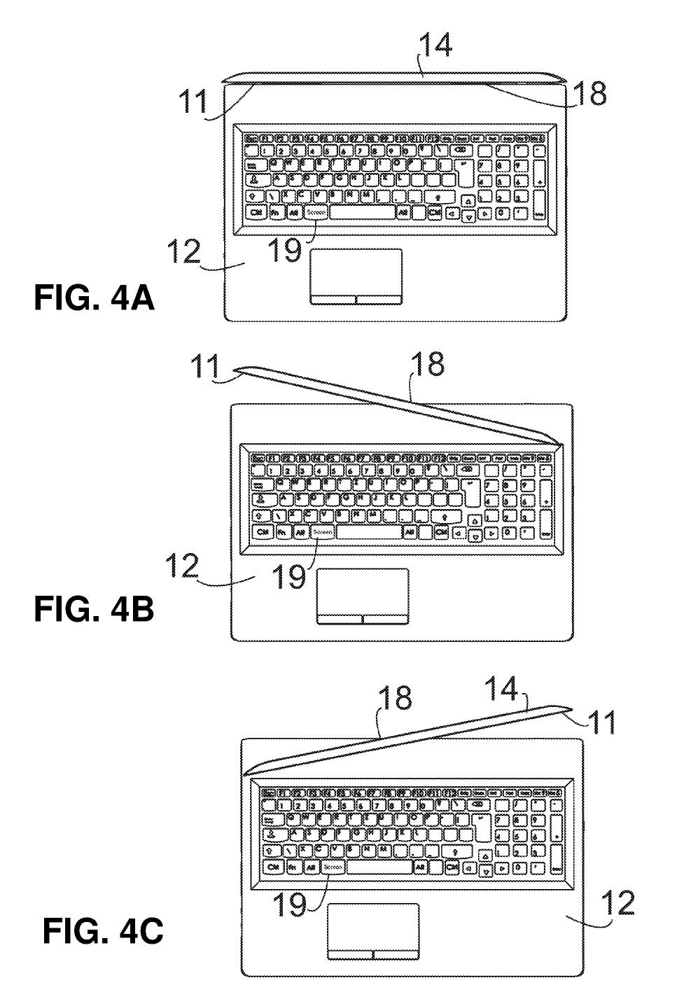

FIGS. 4A, 4B and 4C show the laptop computer 10 with the screen in a normal position 4A and in rotated positions 4B and 4C. In case, user's face is not in front of the screen, the present system rotates the screen 11 to a user's preference or to a position that the user's face and the screen 11 are parallel and user's face is located in the middle of the screen 11.

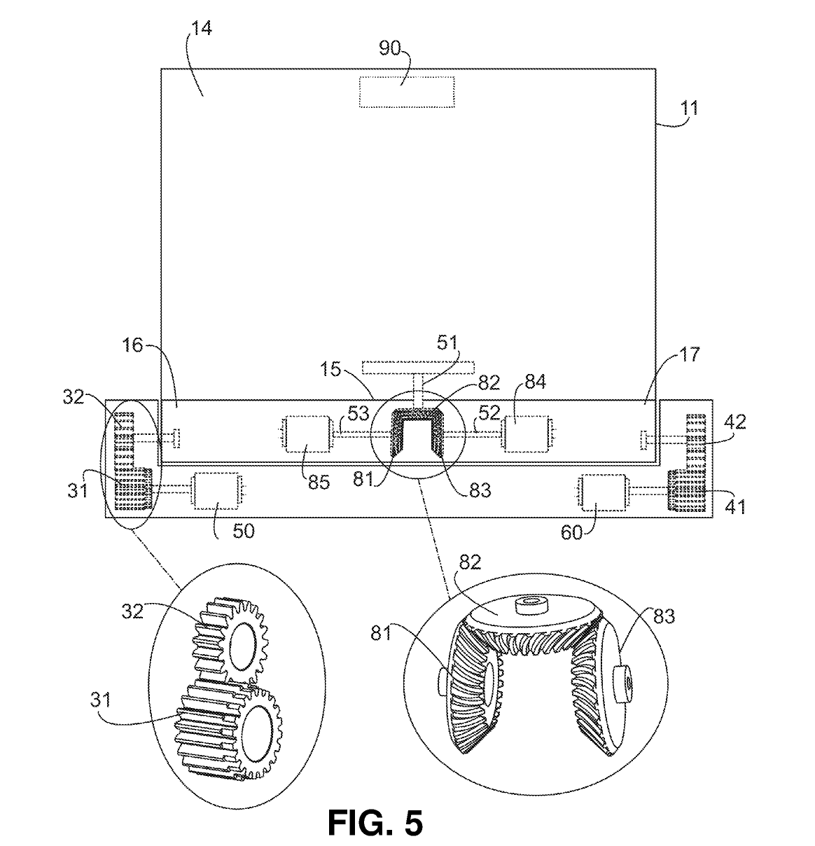

FIG. 5 shows the back side 14 of the screen 11. Pair of gears 31-32 and 41-42 coupled to the screen 11 open and close the screen. The pair of gears 31-32 and 41-42 can tilt the screen 11 to an open or a closed position. The first set of gears 31, 41, which are coupled to the second set of gears 32, 42, are operated by an electric motors 50, 60. The location and the position of the gears 30 and 40 may be different based on different configurations of the laptops 10 or computer monitors.

The pair of gears 31-32 and 41-42 are connected laterally to a distal end 16 and a proximal end 17 of the screen 11. The gears 31-32 and 41-42 and motors 50 and 60 are embedded in a laptop case near the screen 11. The operation of the gears 31-32 and 41-42, which are coupled to the motors 50 and 60, are managed by the CPU of the laptop.

Again as shown in FIG. 5, the screen 11 further has three bevelled gears 81-83 coupled to the screen 11. The bevelled gears 81-83 provide screen rotation for the present assembly. The bevelled gears 81-83 are driven by two electric motors 84-85 to provide rotation to the right and left. The bevelled gears 81-83 are coupled to two electric motors 84-85 and are embedded inside the laptop case in the middle portion 15 of the screen 11.

The bevelled gear of the present invention is selected from the groups consisting of a straight bevelled gear, a spiral bevelled gear, a zerol bevelled gear and a hypoid bevelled gear. The mentioned bevelled gears can be designed in such a way to perform a rotation for the screen 11. Bevelled gears provide a change in direction between the input shafts 52-53 and output shaft 51. FIG. 5 shows a 90 degree change in the direction for the purpose of the present invention.

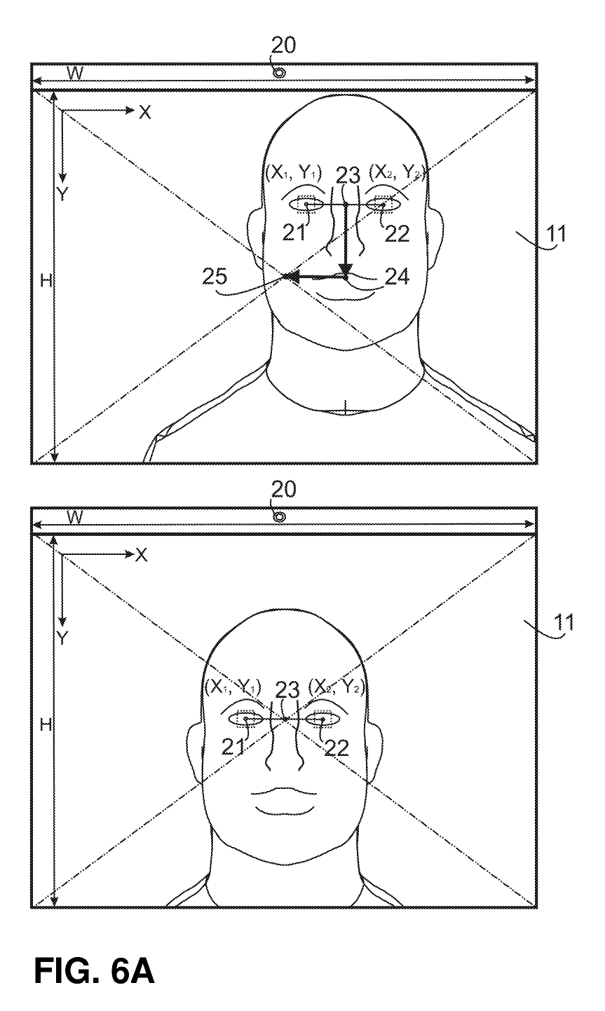

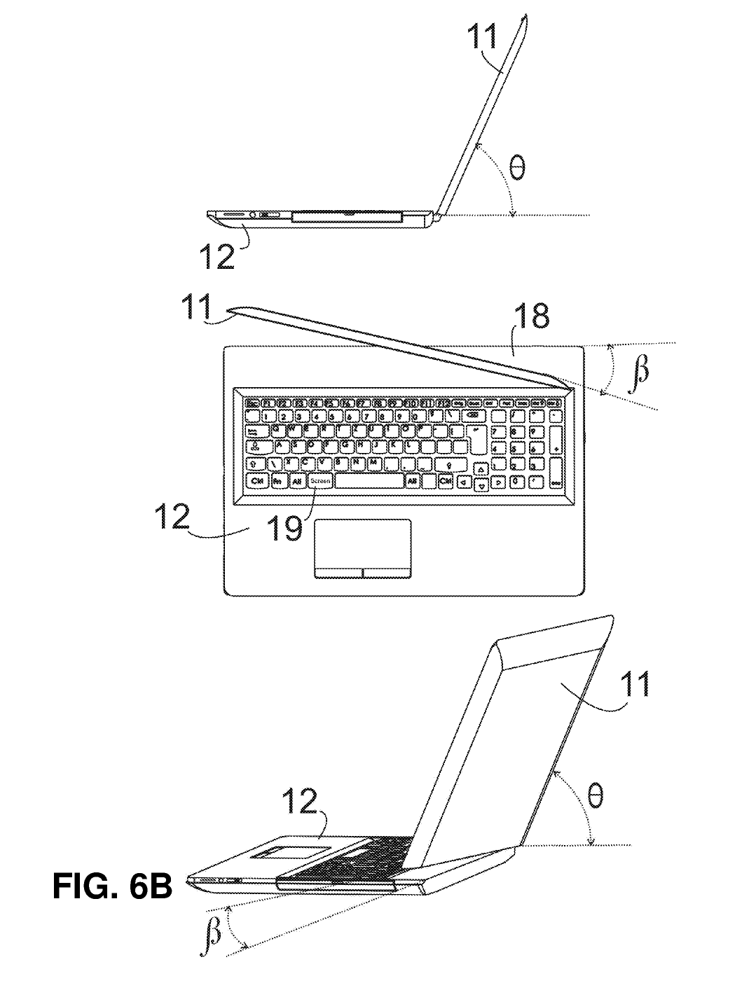

Again as shown in FIG. 5, an accelerometer 90 designed and installed in the interior part of the screen 11 to use for screen alignment angles' feedback. The accelerometer 90 of the present invention senses the tilt movement of the screen 11. The accelerometer 90 measures the angles θ and β as shown in FIG. 6B. The accelerometer 90 designed in the screen to send the angle's feedback to the CPU. The accelerometer 90 feedback also can be used to detect the preferred position of the screen, which is selected by the user and can be referred to when the position of the screen is changed.

The alignment algorithm of the present invention is shown in FIG. 6A. The camera 20 detects user's eyes 21, 22. The detection can be done by any eye or face detection algorithm, which are known in the industry.

W: Width of the screen (pixels)

H: Height of the screen (pixels)

W×H: Resolution (pixels)

(X₁, Y₁): Coordinates for eye 1 (pixels)

(X₂, Y₂): Coordinates for eye 2 (pixels)

(X_{Ideal}, Y_{Ideal}): The best average eyes' location on the screen

By assuming that the best position for the user is when the eyes of the user are in the middle of the screen 11, the desired average eye location 25 in the screen 11 is calculated by:

$$( {X}_{Ideal} , {Y}_{Ideal} ) \text{:} ( \frac{L}{2} , \frac{H}{2} )$$

By taking the average of the coordinates of user's eyes 23, the average position of user's eyes is calculated according to:

$$( {X}_{Current} , {Y}_{Current} ) \text{:} ( \frac{{X}_{1} + {X}_{2}}{2} , \frac{{Y}_{1} + {Y}_{2}}{2} )$$

The software of the present invention will move the screen 11 from its current position 23 to an ideal position 25. The ideal position 25 is defined by a user. The default condition for the ideal position is the middle of the screen.

Again as shown in FIG. 6A, for the vertical alignment, the software moves the screen 11 from point 23 to 24 and for the horizontal alignment, from point 24 to 25. The ideal position 25 for the average coordinates for one's eyes are achieved by combination of the vertical and the horizontal movement.

As shown in FIG. 6B, the present invention uses image processing to calculate the current position of user's eyes, and moves the screen so the eyes are located in the ideal position. The software controls the screen's position by the motors and the accelerometer feedback (motor movement, e.g. 1 degree), and keep processing the acquired frames by the camera at the same time, until the user's eyes are located in the ideal location on the screen. The accelerometer measures the angles θ and β as shown in FIG. 6B. The accelerometer sends the angle information for the vertical and the horizontal alignment to the CPU.

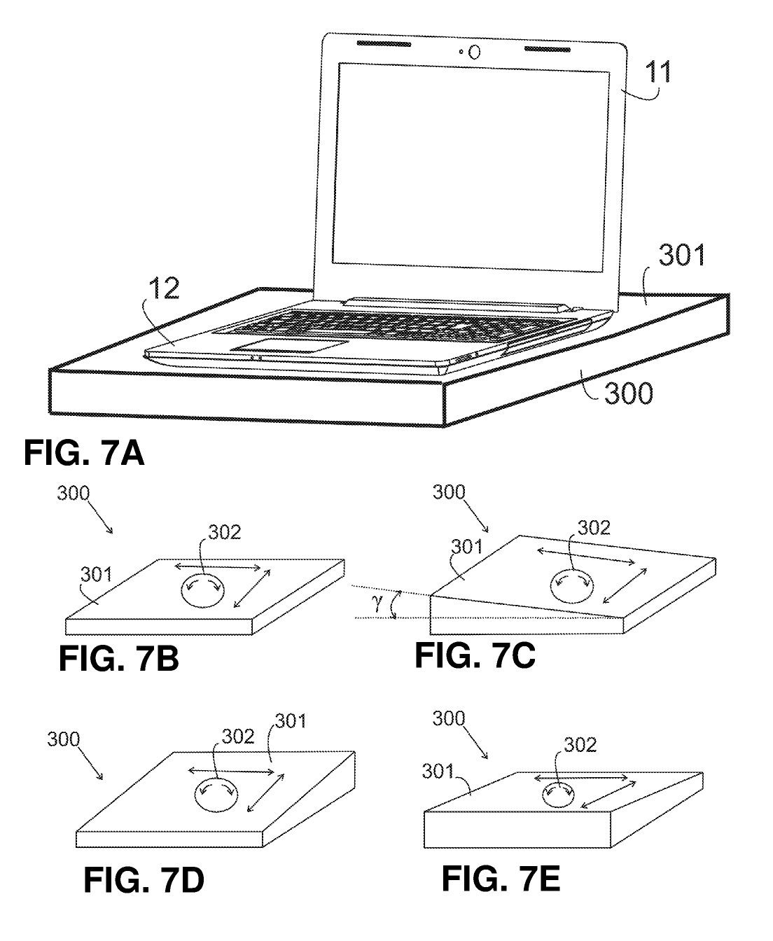

As shown in FIG. 7A, in another embodiment of the present invention the positioning mechanism can be done by a platform 300. The platform comprises of a platform surface 301 that is attached to a bottom portion of the screen and has means to tilt and rotate the screen. The different modes of the platform 300 are shown in FIGS. 7B, 7C, 7D, 7E. The platform comprises of an adjustable surface 301, the adjustable surface 301 has a width, a length and a height. A platform means can change the width, the length and the height of the surface 301. The platform 300 also has an area 302 which can rotate the screen and control the distance between the user and the screen. The area 302 can be designed in the middle of the adjustable surface 301 and the screen which can be a laptop computer, a desktop computer or a smart TV can be placed on top of the area 302.

Again as shown in FIG. 7C, the accelerometer in the present invention can measure the third angle y and gives feedback to the alignment system to move the screen to the preferred position.

The platform 300 in this embodiment is incorporated with image processing system of the present invention, to determine the user's face or eyes and align the screen by obtaining the best position based on the position of the user near the screen.

The platform means for the changing the platform surface 301 can be a plurality of miniature pumps distributed on the surface 301 to move up and down to align the screen. The platform surface is flexible and can be adjustable in its length, width and height.

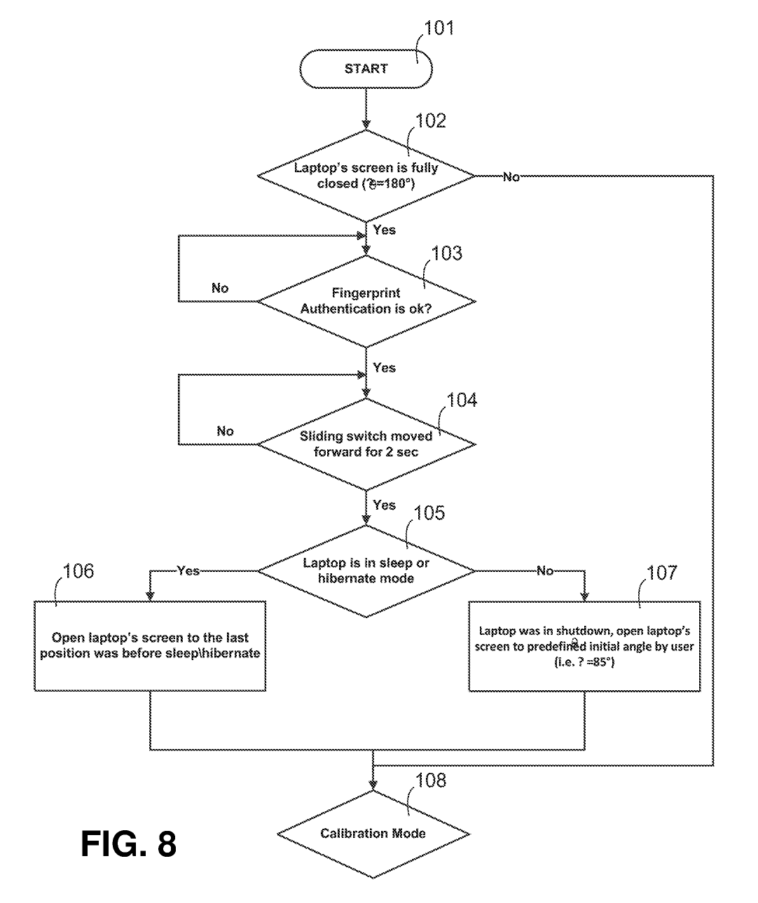

FIG. 8 shows a schematic diagram of the opening mechanism for the present invention. The algorithm starts 101 by checking the laptop status. If the laptop's screen is fully closed 102 and the finger authentication 103 is OK, then the laptop screen opens to the last position 106 before the sleep or hibernate modes. If the laptop is in the shut off mode, the screen opens to the predefined initial angle 107 by sliding and holding the sliding switch forward for two seconds 104. If the laptop's screen is not fully closed, the user may use the Calibration Mode 108.

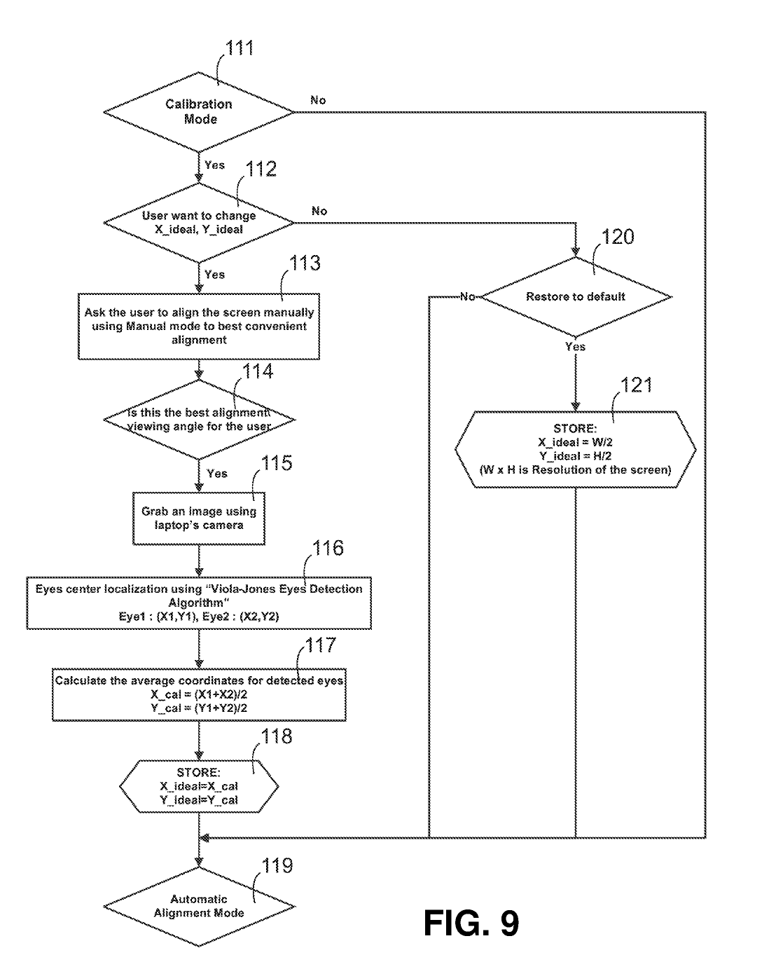

FIG. 9 shows a schematic diagram for the calibration mode 111 of the present invention. If the user's preference for the ideal location of the eyes is different from the center of the screen, the user can change the ideal position 112. The system asks the user to align the screen manually using manual mode to his/her preferred alignment 113. If the user confirms the new alignment 114, the system will grab an image 115 of user's face in the desired position and calculates eyes location on the screen 116-118 for the future automatic alignment mode 119. If the center of the screen is the user preference for the eyes, the system restores the eyes location 120-121.

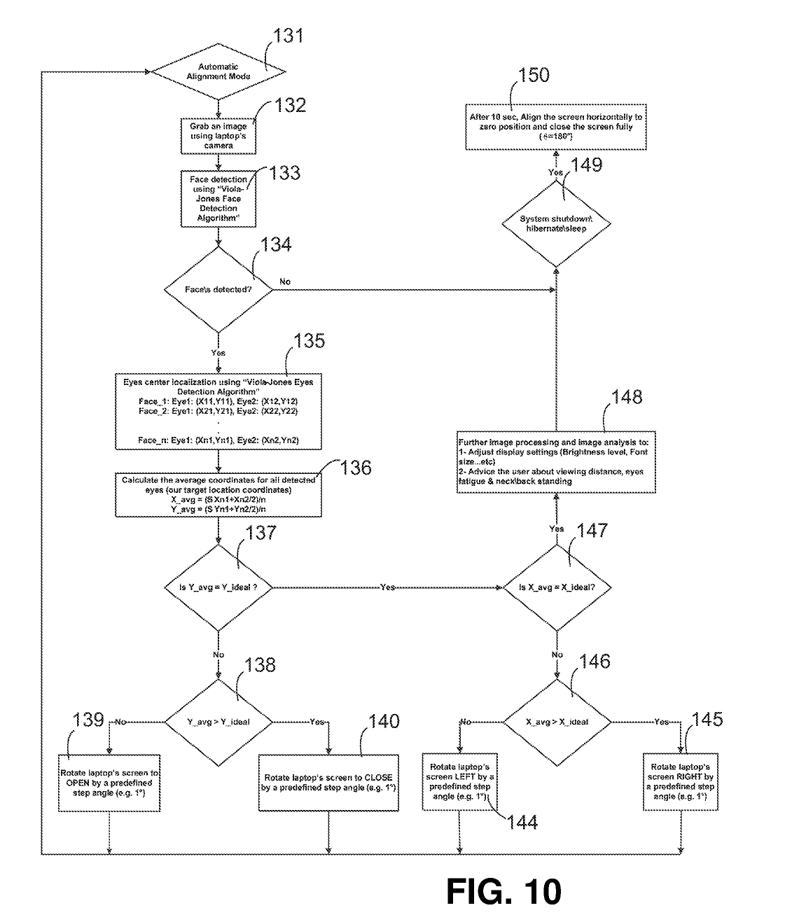

FIG. 10 shows a schematic diagram for the automatic alignment mode 131 of the present system. The screen camera 132 will take an image and start the face detection process. Any face detection algorithm, such as viola-Jones face detection algorithm 133, can be used. If the system detects a face 134, then the center of the eyes 135 is determined and the average coordinates for eyes 136 are calculated.

The algorithm checks the vertical alignment 137-138 by opening\closing the screen 139-140 until the Y_avg is equal to Y_ideal 137. If Y_avg=Y_ideal this means that the vertical alignment is completed and the horizontal alignment should be performed 144-147. The algorithm rotates the screen until the X_avg is equal to X_ideal 147.

Again as shown in FIG. 10, once the automatic alignment is completed, the algorithm performs display adjustment and advises the user 148. In case of shut down, hibernate or sleep modes 149, the algorithm will rotate the screen to the home position and fully closes it after a predefined period of time 150.

Again as shown in FIGS. 4A, 4B, 4C a SCREEN key 19 is designed in the keyboard for alignment of the laptop's screen. The user can use the SCREEN key 19 with the arrow keys to align the screen manually.

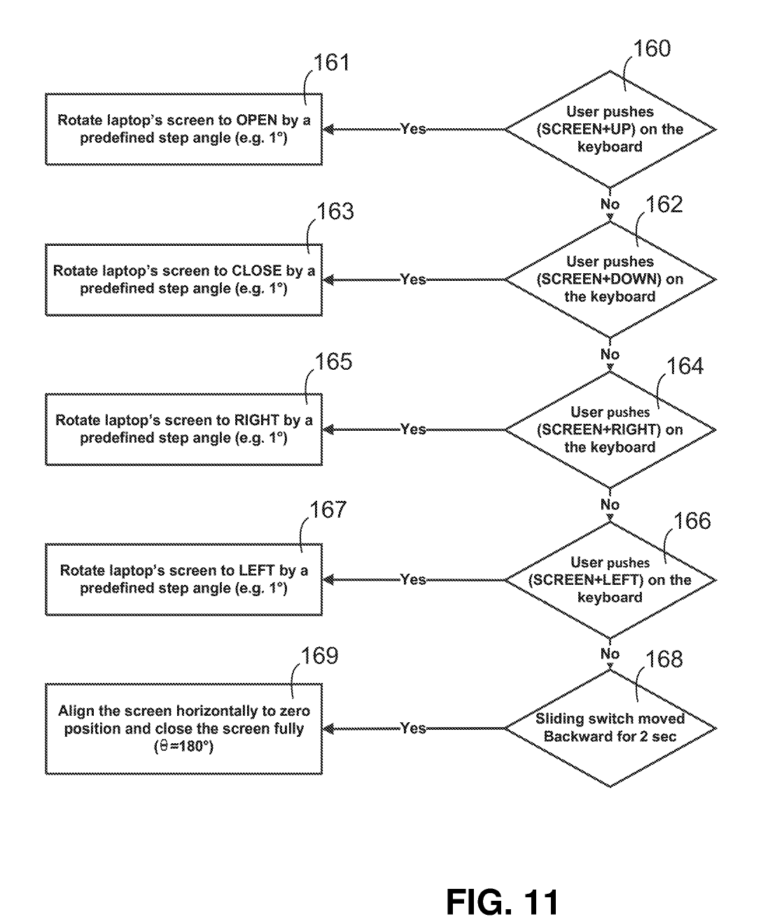

FIG. 11 shows a schematic diagram for the manual alignment mode by a user. The user can use the SCREEN key with the arrow keys to align the screen to the left and right or up and down. If the user pushes the SCREEN key with the UP key on the keyboard 160, the laptop screen rotates 1 degree to the open position 161. The steps for other alignments are shown in blocks 162-169.

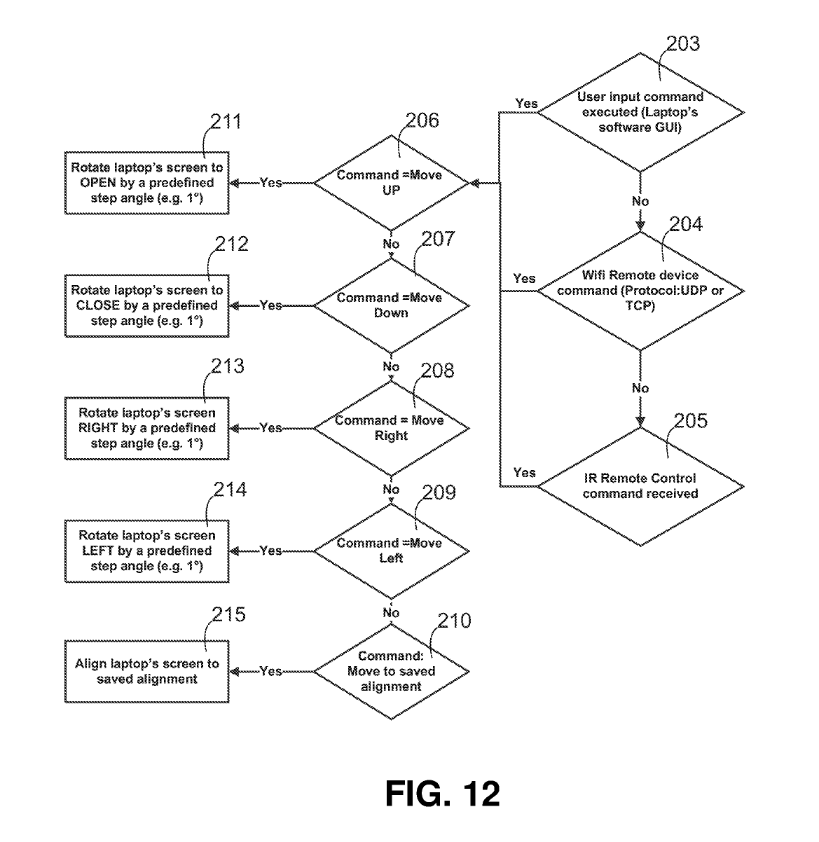

The alignment of the screen can be done by a graphical user interface (GUI) 203 on the aligned screen, or by a Wi-Fi remote device 204, such as a mobile phone or by an IR remote control 205 as shown in FIG. 12. Steps 206-215 for alignment and rotation of the laptop screen is shown in the schematic diagram 206-215 of FIG. 12. FIG. 1 also shows an example of a graphical user interface (GUI) 27 which can be displayed on the screen to align the screen manually.

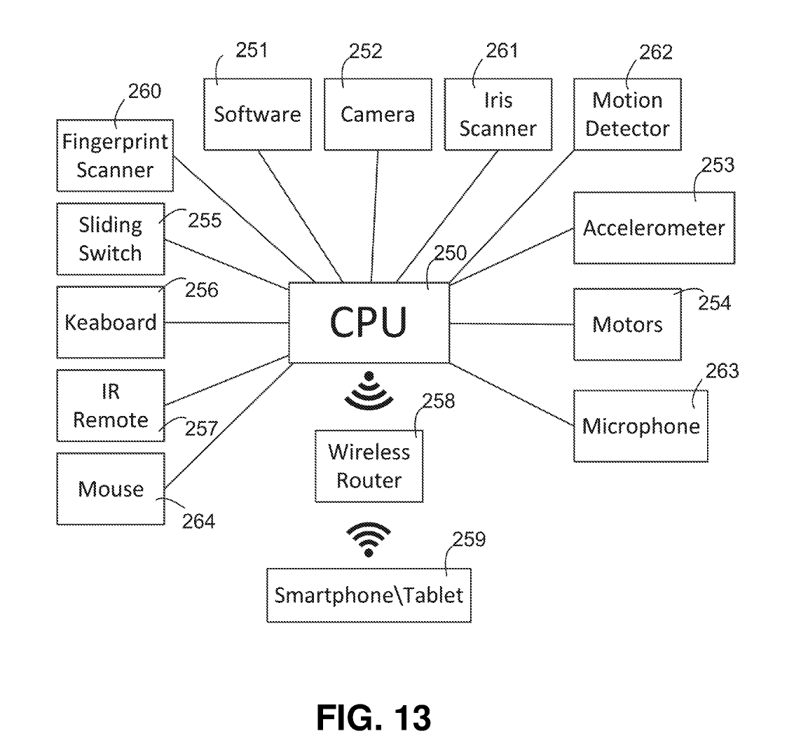

FIG. 13 shows a schematic diagram of the whole structure of the present invention. The central processing unit (CPU) 250 of the computer manages the operation of the camera 252 to take an image for image processing by the software 251. The CPU 250 also manages the motors 254 and the accelerometer 253 for the alignment of the screen. The operation of the fingerprint scanner 260, motion detector 262, mouse 264, an iris scanner 261, a microphone 263, the sliding switch 255, keyboard 256, IR remote 257 and smart phone or tablet 259, which are connected to the computer by a wireless router is done by the CPU 250.

In another embodiment of the present invention, the system further has a motion detector which detects the movement of the user and activates the automatic alignment mode based on the position of the user's face and the angle of the user's face with respect to the screen.

In another embodiment of the present invention, the whole process of alignment of the screen can be done automatically in a predefined period of time. For example, the system can automatically align the screen every 5 minutes to make sure the user's face or the user's eyes are in the ideal location in the screen.

In another embodiment of the present invention as shown in FIG. 13, an iris scanner 261 can be added to the system to keep the laptop's screen open for authorized user, and automatically fully close it for unauthorized user in a specific period of time for security purpose.

In another embodiment of the present invention, for communication between the user and the alignment system a voice recognition can be used for alignment of the screen. The user can command to the system such as Rotate to the left! Or Open the screen! etc. The commends are received to the software via a microphone 263 as shown in FIG. 13.

In another embodiment of the present invention a mouse 264 can be used for the alignment of the screen. The user can press the SCREEN key 19 and moving the mouse 264 accordingly to align the screen, open the screen, close the screen or rotate the screen. The user also can press SCREEN 19 key and scroll the mouse's scroll wheel forward or backward to open and close the screen respectively as shown in FIG. 13.

The present device can be used in any type of monitors, including desktops, laptops and smart TV's. An external camera can be used if the screen or the monitor does not have an internal camera. The present system can be programmed to embody the size of a desktop monitor or a TV screen.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

1. An alignment system for a screen for optimum view by a user, said system comprising:
a. a positioning mechanism attached proximate a bottom of the screen to adjust the position of the screen by horizontal rotation for vertical angular position of said screen and vertical rotation for horizontal angular position of said screen;
b. a camera located on the screen to capture an image of the user's face;
c. an image processor to determine the position of the user's eyes with respect to the screen;
d. a preferred location determinator to define a preferred position for said user's eyes with respect to the screen; and
e. an optimum view determinator to adjust the screen angularly vertically and horizontally for the optimum view of the screen by the user,
whereby, said camera automatically and continuously captures said user's image when stationary and in motion and automatically and continuously adjusts the screen location and angle for optimum view by the user.

2. The alignment system of claim 1, wherein said positioning mechanism comprises a platform attached to a bottom portion of said screen, said platform allowing for tilting and rotation of the screen.

3. The alignment system of claim 2, wherein said platform further comprises:
a. a pair of lateral gears coupled to a lateral motor, said lateral gears for tilting said platform;
b. a set of bevelled gears coupled to a bevelled motor, said bevelled gears for rotating said platform; and
c. an accelerometer for determining an angle of said platform with respect to a horizon.

4. The alignment system of claim 2, wherein said platform further comprises:
d. a tilting mechanism for tilting said platform;
e. a rotation mechanism for rotating said platform; and
f. an angle determining mechanism for determining an angle of said platform with respect to a horizon.

5. The alignment system of claim 1, wherein said optimum view determinator comprises a location of the user's eyes with respect to the screen, and wherein said screen is considered to be aligned if the user's eyes are aligned with the middle of the screen.

6. The alignment system of claim 1, wherein said optimum view determinator comprises a location of the user's face with respect to the screen, and wherein said screen is considered to be aligned if the user's face is aligned with the middle of the screen.

7. The alignment system of claim 1, further having a motion detector for detecting movement of said user and automatically activating the alignment system.

8. The alignment system of claim 1, wherein said alignment system is remotely commanded by an infrared device, a Wi-Fi device, a mouse or a voice command.

9. The alignment system of claim 1, further having a control switch for manual operation of the positioning system to align said screen to a desired position.

10. The alignment system of claim 1, wherein said screen is selected from the groups consisting of a laptop screen, a desktop screen, a smart TV screen.

11. A method for automatic and continuous alignment of a screen for optimum viewing by a user, said screen having an upper side, a left side, a screen-width and a screen-height, said method comprising of steps of:
a. capturing an image of said user and importing said captured image on said screen;
b. defining an X-axis as said upper side of said screen;
c. defining an Y-axis as said left side of said screen;
d. determining a current location of said user's face or said user's eyes based on said X-axis and Y-axis;
e. defining a preferred location for said user's face or user's eyes on said screen based on said X-axis and Y-axis;
f. adjusting said screen from said current location to said preferred location in said Y-axis direction;
g. adjusting said screen from said current location to said preferred location in said X-axis direction; and
h. repeating steps f and g as required based on the current location of said user in relation to said screen.

12. The method of claim 11, wherein said preferred location is in a middle of said screen.

13. The method of claim 11, wherein said method further comprises a detecting step for detecting movement of said user and automatically activating the method.

14. A self-aligning laptop computer screen system comprising:
a. a laptop computer having a screen, said screen having a distal end, a proximal end, and a middle portion, said screen hingedly coupled to a keyboard;
b. a camera to capture an image of a user;
c. a pair of lateral gears coupled to a lateral motor, said lateral gears connected to said screen from said distal and said proximal ends to tilt said screen;
a. a set of bevelled gears coupled to a bevelled motor, said bevelled gears connected to said middle portion of said screen to rotate said screen;
b. an accelerometer for determining an angle of said screen with respect to a horizon; and
c. a process for determining a current position of said user's face on the screen based on said image and for calculating a desired position for alignment of the screen.

15. The self-aligning laptop computer screen system of claim 14, wherein said pair of lateral gears comprises a first gear connected to said lateral motor and a second gear connected to said screen, whereby said first gear drives said second gear.

16. The self-aligning laptop computer screen system of claim 14, wherein said set of bevelled gears is selected from the group consisting of a straight bevelled gear, a spiral bevelled gear, a zerol bevelled gear and a hypoid bevelled gear.

17. The self-aligning laptop computer screen system of claim 14, wherein said set of bevelled gears comprises a first bevelled gear connected to said screen, a second and a third bevelled gear connected to two said bevelled motors, said first bevelled gear is in a 90 degree relation with respect to said second and third bevelled gears.

18. The self-aligning laptop computer screen system of claim 14, wherein said keyboard further comprises a screen key to perform manual screen alignment.

19. The self-aligning laptop computer screen system of claim 14, wherein said system further comprises a sliding switch for manual screen vertical alignment, and opening and closing of said screen.

20. The self-aligning laptop computer screen system of claim 19, wherein said system further comprises a fingerprint scanner for activating said sliding switch and an iris scanner for keeping the screen open for an authorized user.

21. The alignment system of claim 1 for use with a plurality of users.

22. The method of claim 11 for automatic and continuous alignment of a screen for optimum viewing by a plurality of users.

23. The computer screen system of claim 14 for use with a plurality of users.
